(19) United States
(12) Patent Application Publication
(10) Pub. No.: US 2023/0323076 A1
(43) Pub. Date: Oct. 12, 2023

(54) COMPOSITE MATERIAL FOR A PASSIVE VARIABLE RADIATOR

(71) Applicant: Toyota Motor Engineering & Manufacturing North America, Inc., Plano, TX (US)

(72) Inventors: Songtao Wu, Ann Arbor, MI (US); Debasish Banerjee, Ann Arbor, MI (US); Charles Alexander Roberts, Farmington Hills, MI (US); Taizo Masuda, Yokohama-shi (JP); Yuki Kudo, Susono-City (JP)

(21) Appl. No.: 17/716,546

(22) Filed: Apr. 8, 2022

(51) Int. Cl. C08K 3/08; C08L 83/04

(52) U.S. Cl. CPC C08K 3/08; C08L 83/04; C08K 2201/005; C08K 2201/014; C08K 2003/0862; C08K 2201/001

(57) ABSTRACT

A composite material includes a polymer matrix and a quantity of electrically conductive microparticles dispersed within the polymer matrix in an amount and distribution structured so that the composite material exhibits an increase in thermal emissivity of at least about 8% with increasing temperature of the composite material, for temperatures over a range of 23° C.-60° C. inclusive. The composite material may be used as (or as part of) a passive variable radiator for cooling an object in thermal communication with the composite material.

### TECHNICAL FIELD

The present disclosure generally relates to materials having high emissivities and, more particularly, to a material structured to have a relatively high emissivity ε for electromagnetic energy in the 8-13 μm wavelength range.

### BACKGROUND

It has been found that the Earth's atmosphere is largely transparent to electromagnetic emissions having wavelengths in the range 8-13 μm (micrometers) inclusive. Thus, electromagnetic emissions in this 8-13 μm wavelength range may efficiently pass from objects at or near the Earth's surface through the atmosphere and out into space without appreciable atmospheric interference or absorption. Accordingly, it would be desirable to enable an object or device to radiate excess thermal energy in this wavelength range so that the object/device may be cooled in a variety of weather conditions and also during periods of elevated ambient temperature.

### SUMMARY

In one aspect of the embodiments described herein, a composite material includes a polymer matrix and a quantity of electrically conductive microparticles dispersed within the polymer matrix in an amount and distribution structured so that the composite material exhibits an increase in thermal emissivity of at least about 8% with increasing temperature of the composite material, for temperatures over a range of 23° C.-60° C. inclusive.

In another aspect of the embodiments described herein, a composite material includes a polymer matrix having a thermal emissivity of at least 0.95 over a temperature range of 23° C.-60° C. inclusive, and a quantity of electrically conductive flaky microparticles dispersed within the polymer matrix in an amount of 30%±1% by volume.

In another aspect of the embodiments described herein, a composite material includes a polymer matrix having a thermal emissivity of at least 0.95 over a temperature range of 23° C.-60° C. inclusive, and a quantity of electrically conductive spiky microparticles dispersed within the polymer matrix in an amount of 30%±1% by volume.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1 is a schematic perspective view of a sample of a composite material structured in accordance with an embodiment described herein to function as a passive variable radiator (PVR).

FIG. 2 is a schematic cross-sectional side view of a portion of a PVR in accordance with an embodiment described herein, illustrating operation of the PVR.

FIG. 3A is a schematic view of a collection of flaky-shaped microparticles prior to incorporation of the microparticles into a polymer matrix.

FIG. 3B is a magnified view of a portion of a composite material sample incorporating flaky-shaped microparticles suitable for use in an embodiment of a PVR as described herein.

FIG. 4A is a magnified view of a collection of spiky-shaped microparticles suitable for use in fabricating an embodiment of a PVR-suitable composite material as described herein.

FIG. 4B is a magnified view of a portion of a composite material sample incorporating spiky-shaped microparticles as shown in FIG. 4A, in another embodiment of a PVR as described herein.

FIG. 5A is a magnified view of a collection of spherical microparticles suitable for use in fabricating an embodiment of a PVR-suitable composite material as described herein.

FIG. 5B is a magnified view of a portion of a composite material sample incorporating spherical microparticles as shown in FIG. 5A, in yet another embodiment of a PVR as described herein.

FIG. 6 is a graph showing the change in thermal emissivity with temperature in a composite material sample incorporating each microparticle shape, over the temperature range 23° C.-60° C.

FIG. 7 is a bar graph summarizing changes in thermal emissivity over the temperature range 23° C.-60° C. for composite material samples, each sample including 30% by volume of one of the shapes of microparticle tested.

FIG. 8A is a graph showing a distribution of spectral radiance of a blackbody as a function of wavelength at a temperature of 60° C.

FIG. 8B is a magnified view of a portion of the graph shown in FIG. 8A.

FIG. 9 is a graph showing continuous curves of changes in thermal emissivity ε_{T} over the temperature range 23° C.-60° C. as a function of wavelength λ, for samples of PDMS alone (i.e., with no microparticles added) and for samples including the various microparticle shapes tested at 30%±1% by volume.

FIG. 10 is a graph comparing the thermal emissivities of two separate PDMS polymer materials in the wavelength range of 8-13 μm inclusive.

FIG. 11A is a graphical representation of the change in thermal emissivity of a composite material sample incorporating 10%±1% spiky Ni microparticles by volume, for several sample temperatures and over a range of different wavelengths.

FIG. 11B is a graphical representation of the change in thermal emissivity of a composite material sample incorporating 20%±1% spiky Ni microparticles by volume, for the same temperatures and over the same range of wavelengths as shown in FIG. 11A.

FIG. 11C is a graphical representation of the change in thermal emissivity of a composite material sample incorporating 30%±1% spiky Ni microparticles by volume, for the same temperatures and over the same range of wavelengths as shown in FIG. 11A.

FIG. 11D is a graphical representation of the change in thermal emissivity of a composite material sample incorporating 40%±1% spiky Ni microparticles by volume, for the same temperatures and over the same range of wavelengths as shown in FIG. 11A.

FIG. 12A shows the change in emissivity with temperature for a composite material sample incorporating spiky nickel microparticles at 30%±1% by volume and using Sylgard™ 184 as the polymer matrix material.

FIG. 12B shows the change in emissivity with temperature for a composite material sample incorporating spiky nickel microparticles at 30%±1% by volume and using Ecoflex™ 20 as the polymer matrix material.

FIG. 13A is a graph showing the variation in change of emissivity with wavelength at various temperatures for a composite material sample incorporating spiky nickel microparticles at 30%±1% by volume and having a thickness of 0.004±0.0004 inch.

FIG. 13B is a graph showing the variation in change of emissivity with wavelength at various temperatures for a composite material sample incorporating spiky nickel microparticles at 30%±1% by volume and having a thickness of 0.040±0.0004 inch.

FIG. 13C is a graph showing the variation in change of emissivity with temperature for composite material samples incorporating spiky nickel microparticles at 30%±1% by volume and having thicknesses of 0.004±0.0004 inch and 0.040±0.0004 inch.

It should be noted that the figures set forth herein are intended to exemplify the general characteristics of the methods, algorithms, and devices among those of the present technology, for the purpose of the description of certain aspects. These figures may not precisely reflect the characteristics of any given aspect, and are not necessarily intended to define or limit specific embodiments within the scope of this technology. Further, certain aspects may incorporate features from a combination of figures.

### DETAILED DESCRIPTION

It has been found that the Earth's atmosphere is largely transparent to electromagnetic emissions having wavelengths in the range 8-13 μm (micrometers) inclusive. Wavelengths in this range form a portion of the infrared range (i.e., wavelengths in the range 1-100 μm inclusive) of the electromagnetic spectrum. Electromagnetic emissions in this 8-13 μm wavelength range may efficiently pass from objects at or near the Earth's surface through the atmosphere and out into space without appreciable interference or absorption. Embodiments described herein relate to a composite material structured for use as a passive variable radiator (PVR). The radiator formed by the composite material is passive because it automatically and inherently radiates heat in the wavelength range of 8-13 μm as the thermal emissivity of the material increases with increasing temperature of the material. The composite material may be heated by thermal communication with an object which receives and/or generates heat. As the temperature of the composite material increases, heat from the composite material may be radiated through the atmosphere. In this manner, the composite material may be used to cool the object or to receive and radiate excess heat from the object to prevent the temperature of the object from rising.

For purposes described herein, the emissivity ε of a material or structure at a given temperature T may be defined as a ratio of the total emissive power of the material or structure to the total emissive power of a perfectly black body at the same temperature. The emissivity ε is a measure of the effectiveness of a material/structure in emitting energy as thermal radiation. The emissivity ε may vary between 0.0 and 1.0. A blackbody in thermal equilibrium has an emissivity of ε=1.0. Real objects do not radiate as much heat as a perfectly black body. Also for purposes described herein, emissivity of materials/structures within in the 8-13 μm wavelength range may be termed “thermal emissivity” or “ET”.

It has been found that metals generally exhibit relatively low thermal emissivities. Also, certain polymers have relatively high thermal emissivities within a specific temperature range of the material. Thus, in a composite material formed by adding a quantity of metal to a relatively high thermal emissivity polymer, the composite material may have a relatively lower thermal emissivity ε_{T} than the base polymer. It has also been found possible to structure a composite material so that the thermal emissivity ε_{T} of the composite material varies with the temperature of the composite material. It has been found that this may be done by incorporating the metal into a matrix formed from a material having a relatively high coefficient of thermal expansion (CTE). This may produce a material in which the thermal emissivity ε_{T} increases with increasing temperature of the composite material and the resulting thermal expansion of the polymer matrix, at least over a certain temperature range.

The present technology provides methods for making and using embodiments of a composite material structured to operate as a passive variable radiator (PVR) having a high emissivity in the 8-13 μm wavelength range. The passive variable radiator may emit energy in this wavelength range through the atmosphere regardless of the weather or the temperature of the atmosphere surrounding the composite material. The emission of radiation in the 8-13 μm wavelength range may operate to transfer heat from or cool the emitting material.

For use as a passive variable radiator, it is desirable that the composite material exhibit a positive correlation between thermal emissivity ε_{T} and the temperature of the composite material (i.e., that thermal emissivity of the composite material consistently rises with rising temperature of the composite material) over a desired temperature range. It is also desirable that the composite material exhibit as large as possible a change in thermal emissivity over a particular desired temperature range of the composite material. In particular arrangements, the desired temperature range may be 23° C.-60° C. Using principles and materials described herein, the PVR may be structured so that its thermal emissivity consistently increases with increasing temperature of the composite material, and also consistently decreases with decreasing temperature of the composite material.

An embodiment of the composite material may form (or be part of) a PVR structure positionable in thermal communication with an object. As the object is heated, heat may be transferred from the object to the PVR structure. As heat is transferred to the PVR structure, the temperature of the PVR structure may rise, thereby increasing the thermal emissivity ε_{T} of the PVR structure. At least a portion of the heat may then be radiated from the PVR structure through the atmosphere. In this manner, the object in thermal communication with the PVR structure may be cooled.

An embodiment of the composite material can also be used as a passive variable radiative surface covering or coating for an object. As the surface covering/coating is heated (for example, by direct sunlight or elevated ambient atmospheric temperatures), the thermal emissivity of the surface covering/coating may increase. Heat from the surface covering/coating may then be radiated through the atmosphere. In this manner, an object to which the covering/coating is applied may be thermally insulated by the surface covering/coating.

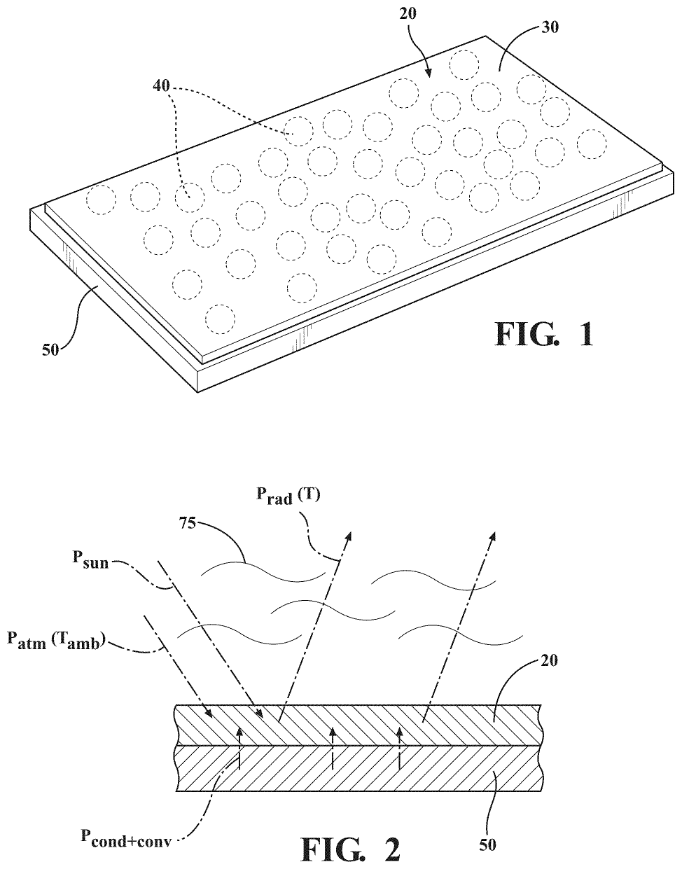

Referring to FIG. 1, in one or more arrangements, a composite material (generally designated 20) usable for a PVR in accordance with embodiments described herein may include a polymer matrix 30 and a quantity of electrically conductive microparticles (generally designated 40) dispersed within the polymer matrix 30. The microparticles 40 may be dispersed within the polymer matrix in an amount and distribution structured so that the composite material exhibits an increase in thermal emissivity ε_{T} of at least about 8% with increasing temperature of the composite material, for temperatures over a range of 23° C.-60° C. inclusive.

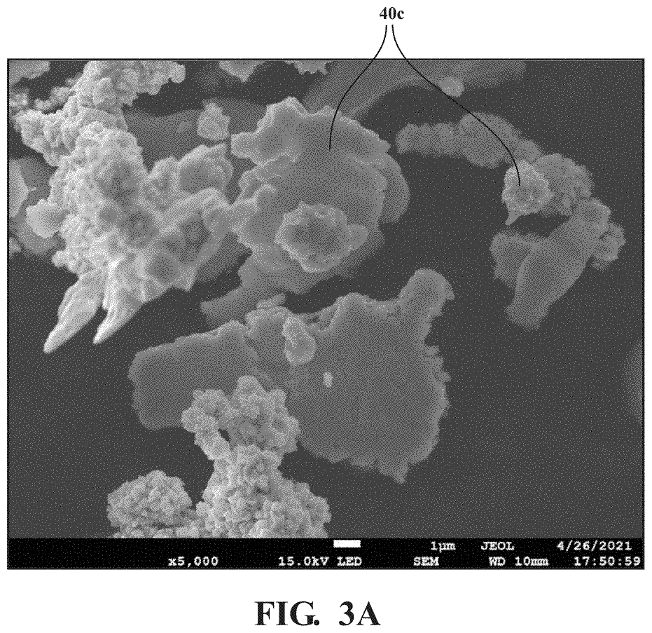

FIG. 2 illustrates operation of an embodiment of a PVR as described herein. FIG. 2 is a schematic cross-sectional side view of a portion of a composite material 20 in accordance with an embodiment described herein, shown in intimate thermal contact with a substrate 50 (for example, a body to be cooled by transferring heat P_{cond+conv} from the substrate 50 to the composite material 20, or a body to be insulated from heat received from an exterior source (e.g., heat Pₐₜₘ (T_{amb}) received from the atmosphere, heat Pₛᵤₙ received from direct sunlight, etc.). As composite material 20 absorbs more heat and the temperature of the composite material 20 rises, the composite material 20 may increasingly radiate heat P_{rad}(T) in the 8-13 μm wavelength range through the atmosphere 75 and out into space.

A “polymer matrix” or “polymeric matrix” may be defined as a continuous polymeric phase in the composite material 20 in which other constituents of the composite material (e.g., the microparticles) are dispersed or suspended. In one or more arrangements, the polymer forming the matrix 30 may have a relatively large coefficient of linear thermal expansion a (i.e., having a value greater than 50×10⁻⁶ C⁻¹).

In one or more arrangements, the polymer forming the matrix may have a relatively high emissivity (e.g., 0.9 or above) for electromagnetic wavelengths in the range 8-13 μm when the polymer is at a temperature within a range of 23° C. to 60° C. inclusive. Non-exclusive examples of suitable materials include grades of polypropylene and polyethylene. In particular non-limiting examples, the polymer forming the matrix may be a bicomponent polydimethylsiloxane (PDMS) resin. One example of a suitable PDMS resin is available from Dow Chemical Co. under the designation “SYLGARD™ 184”.

In one or more arrangements, the electrically conductive microparticles 40 dispersed within the polymer matrix 30 may comprise nickel microparticles, although microparticles formed from other electrical conductors (metallic and/or non-metallic) may alternatively be used. For example, metallic conductors such as copper, silver, iron, or gold may be used. Alternatively, non-metallic electrical conductors such as graphite or graphene may be used. The use of non-metallic conductors may result in a smaller reduction in the emissivity of the matrix material than the use of metallic conductors, thereby providing a composite material with a relatively higher thermal emissivity.

In one or more arrangements, the microparticles 40 incorporated into the composite material 20 may be provided by a suitable microparticle powder dispersed in the PDMS polymer matrix 30. In particular arrangements, the composite material 20 may be formed from a mixture in which the microparticles dispersed in the polymer matrix material comprise 30%±1% of the mixture by volume, with the polymer matrix material comprising 70%±1% of the mixture by volume.

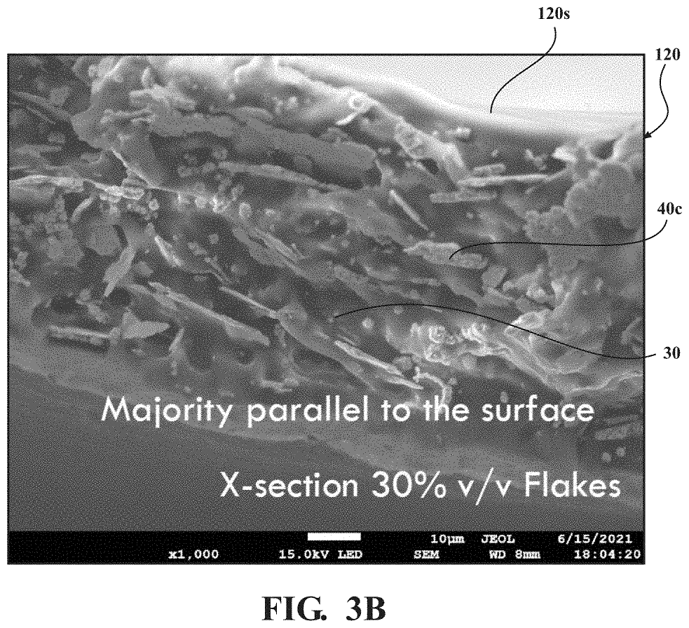

In particular arrangements, the electrically conductive microparticles dispersed within the polymer matrix comprise flaky-shaped microparticles. FIG. 3A is a schematic view of a collection of flaky-shaped microparticles (generally designated 40c) prior to incorporation of the microparticles into a polymer matrix. FIG. 3B shows a magnified view of a cross-section of sample 120 of a composite material incorporating flaky-shaped microparticles with the majority of the flakes arranged so as to extend parallel to an outer surface 120s of the sample 120 of the composite material. In particular arrangements, the flaky-shaped microparticles 40c may have lengths in the range 15-25 μm inclusive and thicknesses in the range 0.5-1.0 μm inclusive. In one or more arrangements, the flaky-shaped microparticles 40c incorporated into the composite material 120 may be provided by a flaky-shaped microparticle powder dispersed in the PDMS polymer matrix 30. A flaky-shaped microparticle powder suitable for preparation of a composite material as described herein is available from Novamet Specialty Products Corporation or Hart Materials Ltd, under the designation “HCA-1”.

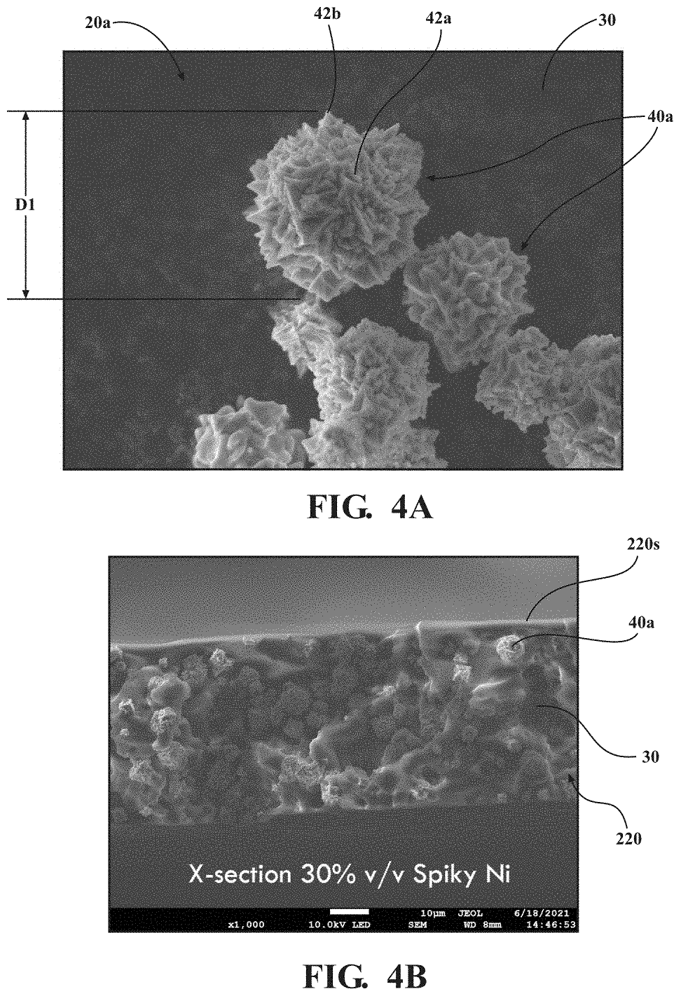

In one or more arrangements, the electrically conductive microparticles dispersed within the polymer matrix comprise spiky-shaped microparticles. FIG. 4A shows a magnified view of examples of spiky-shaped microparticles (generally designated 40a). FIG. 4B shows a magnified view of a cross-section of a sample 220 of a composite material incorporating spiky-shaped microparticles 40a into the polymer matrix 30 adjacent an outer surface 220s of the sample 220. Referring to FIG. 4A, the spiky-shaped microparticles 40a may have generally-spherical central portions 42a with sharp projections or “spikes” 42b extending from the central portion 42a. In particular arrangements, the spiky-shaped microparticles 40a may have overall dimensions D1 (including spikes 42b) in the range 3.8-7.0 μm inclusive. The spikes 42b may have lengths of up to around 0.5 μm, with tips of the spikes having radii of up to 100 nanometers.

In one or more arrangements, the spiky-shaped microparticles 40a incorporated into the composite material sample 220 may be provided by a spiky microparticle powder dispersed in the PDMS polymer matrix 30. A spiky microparticle powder suitable for preparation of a composite material as described herein is available from Vale Canada Ltd. under the designation “Nickel Power Type 123”.

For purposes of experimentally evaluating the variation of thermal emissivity ε_{T} with temperature of composite materials in accordance with embodiments described herein, samples were prepared for testing. The sample fabrication process described herein may be usable for producing test samples using any polymer matrix material and source of microparticles suitable for the purposes described herein.

Embodiments of the composite material were fabricated by combining at least a suitable polymer and a quantity of microparticles to produce various mixtures. For the polymer matrix, the mixtures for each of the initial test samples were formed using SYLGARD™ 184, an embodiment of a bicomponent polydimethylsiloxane (PDMS) resin as previously mentioned. Suitable PDMS resins may have relatively large linear thermal expansion coefficients (i.e., values greater than 50×10⁻⁶° C.⁻¹) and relatively high thermal emissivities (i.e., at least 0.90) at temperatures in the range of 23° C.-60° C. inclusive and at wavelengths in the 8-13 μm atmospheric window. Test samples using SYLGARD™ 184 were also prepared without microparticles for comparing thermal emissivities of the microparticle samples with thermal emissivities of the non-microparticle samples.

Other PDMS resins may also be suitable for the purposes described herein. One group of such resins is available under the designation Ecoflex™, available from Smooth-On, Inc., and also from other sources. The Ecoflex™ materials are a group of two-part platinum-catalyzed silicones which may be mixable in by weight or volume and cured at room temperature with negligible shrinkage. Various grades are available based on viscosity, hardness, pot life and cure time. In one or more arrangements, a composite material suitable for the purposes described herein may be formed using an Ecoflex™ PDMS resin known as Ecoflex™ 00-20. Ecoflex™ 00-20 has a relatively low viscosity (3000 cps), which facilitates mixing with high volume contents of microparticles. Ecoflex™ 00-20 also has a relatively low Shore hardness for large expansion (00-20 based on ASTM D-2240).

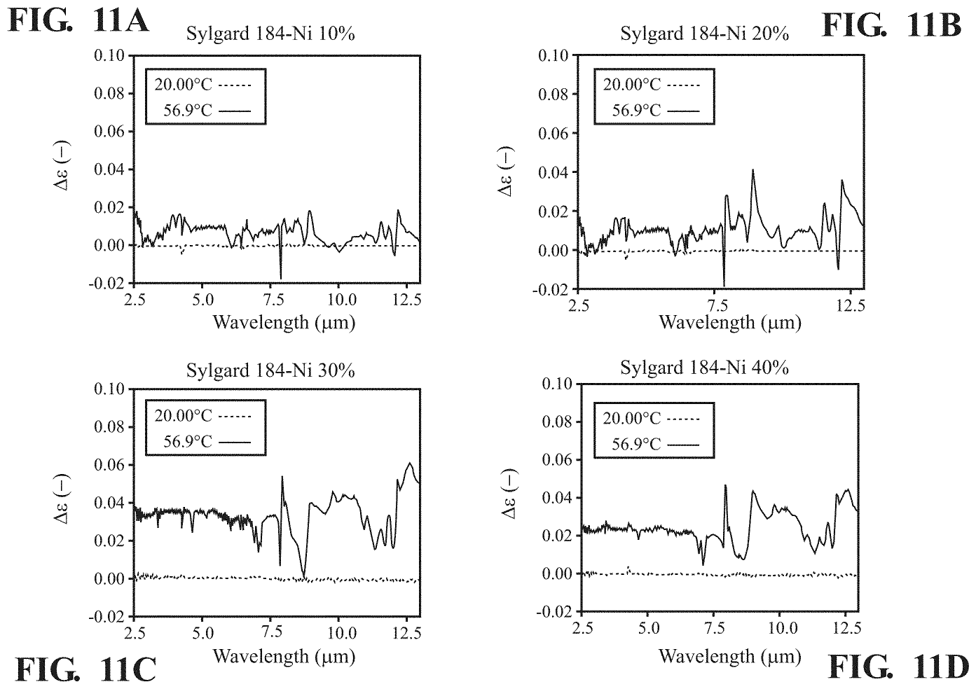

Referring to FIG. 10, based on test data, the Ecoflex™ 00-20 and SYLGARD™ 184 polymers appear to have similar thermal emissivities in the wavelength range of 8-13 μm inclusive.

Referring to again FIGS. 4A and 4B, for purposes of experimentally evaluating the variation of thermal emissivity ε_{T} with the percentage by volume of microparticles incorporated into the composite material, Samples 220 of the composite material were prepared using spiky-shaped nickel microparticles 40a. A suitable spiky-shaped microparticle powder was used to prepare samples at percentages by volume of 10% microparticles/90% polymer, 20% microparticles/80% polymer, 30% microparticles/70% polymer (including the thinner used for the PDMS polymer as described below), and 40% microparticles/60% polymer.

In the samples fabricated for testing, since a PDMA was used for the polymer matrix 30, a suitable PDMA copolymer curing agent was applied each version of the mixture at a weight ratio of 10:1 (polymer to curing agent).

For mixtures using PDMS (or another silicon-based polymer) for the polymer matrix 30 and containing microparticle percentages greater than 20% by volume, a thinner (not shown) may be added to the mixture. For purposes described herein, a suitable thinner is DOW® XIAMETER™ PMX-200 Clear 100 cSt Silicone Fluid, available from Smooth-On, Inc. Addition of the thinner reduces the viscosity of the PDMS resin, enabling the addition of a relatively larger amount of microparticles by volume to the mixture. The thinner also facilitates efficient and non-damaging mixing in mixtures using spiky-shaped microparticles 40a. The resultant consistency of the mixture is also amenable to painting and coating applications. In the test samples described herein containing microparticle percentages greater than 20% by volume, a thinner was added to the mixture in an amount of 10% by weight.

Especially in embodiments using spiky-shaped microparticles 40a as shown in FIGS. 4A-4B, the constituents of the mixture should initially be gently mixed in order to avoid damage or destruction of the nanometric sharp spikes on the spiky-shaped microparticles 40a. For sample preparation purposes, initial mixing was begun by hand for about five minutes using a spatula. The mixture was then mixed for about one minute using a mixing vortex or impeller using a mixing blade. The mixture was then mixed for about one minute using a mixture capable of ultrasonication. The mixture was then further mixed for about 30 seconds in a slurry mixer at 2000 rpm. The mixture was then further mixed by hand for about one minute using a spatula. Initial mixing of the mixture may produce a final paste-like consistency of the mixture. With the steps described above, the paste was mixed until it appeared to be homogenous by visual observation and had a shear rate in the range from 10⁻²-10³ s⁻¹ inclusive.

In one or more arrangements, additional components may be incorporated into the mixtures and/or the mixtures underwent further processing steps after mixing to produce the final composite material. For example, after initial mixing of the material samples, the mixtures for testing were outgassed for about 1 hour under vacuum at room temperature (about 25° C.) to prevent formation of (and to promote elimination of) air bubbles or pockets. Using a suitable doctor blade, sample films of the mixture were then prepared by applying film thicknesses of about 0.004 inch of the mixture to samples of a selected substrate material, in this case a PTFE sheet material.

As a final step in fabrication of the composite material samples, the film samples were then thermally cured in an oven at 80° C. for about one hour. Generally, the mixtures used to make the test samples may be cured at a predetermined temperature for a predetermined time to be determined by product and process requirements.

After sample preparation, the thermal emissivities of the samples were measured using a diffuse-reflectance Fourier-transform-infrared (FTIR) instrument. Using these samples, thermal emissivity data was acquired over the temperature range 23° C.-60° C. to determine the infra-red energy being emitted by the samples at various wavelengths. A heating cell was used to heat the test samples to the temperatures in the 23° C.-60° C. temperature range.

For evaluation of the test samples described herein, a Fourier transform infrared spectrometer (model Thermo Scientific Nicolet 6700) was used to characterize the reflectance of the composite material samples. The spectrometer was equipped with a customized diffuse reflectance accessory which has a 150-mm-diameter integrating sphere and a furnace. A sputtered gold film was used as a reference standard for reflectance comparison. The temperature of the furnace was controlled by a thermal controller equipped with two thermocouples, one located inside the furnace and the other located on the top of the furnace. The composite material sample films were placed on the top of the furnace. An additional thermal couple was used to measure the actual temperature on an outer surface of the sample. The measurements were started after the composite material samples reached steady state temperatures indicative of thermal equilibrium.

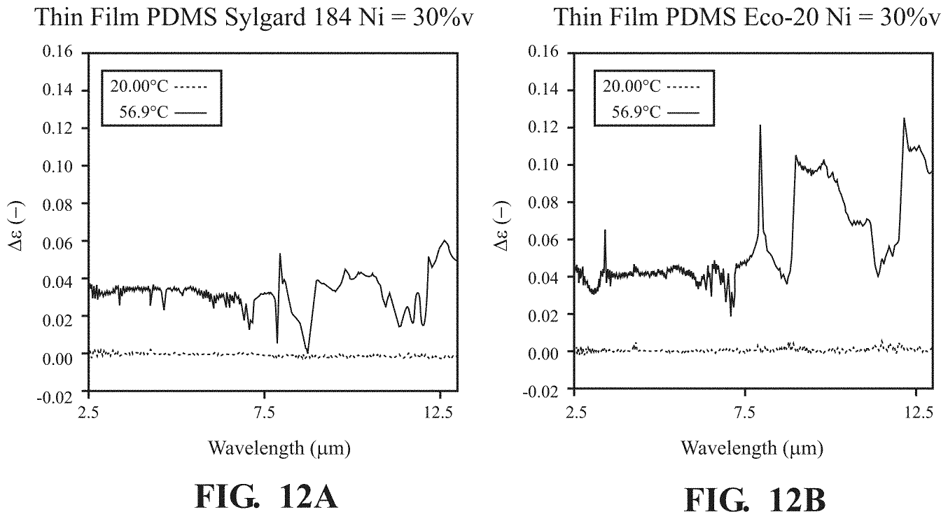

Results of thermal emissivity testing of the spiky-shaped microparticle samples 220 are shown in FIGS. 11A-11D. FIG. 11A is a graphical representation of the change in thermal emissivity of a composite material sample made from SYLGARD™ 184 with 10% spiky Ni microparticles by volume, for several sample temperatures and over a range of different wavelengths. FIG. 11B is a graphical representation of the change in thermal emissivity of a composite material sample made from SYLGARD™ 184 with 20%±1% Ni by volume, for the same sample temperatures and the over same range of wavelengths as shown in FIG. 11A. FIG. 11C is a graphical representation of the change in thermal emissivity of a composite material sample made from SYLGARD™ 184 with 30%±1% Ni by volume, for the same sample temperatures and over the same range of wavelengths as shown in FIG. 11A. FIG. 11D is a graphical representation of the change in thermal emissivity of a composite material sample made from SYLGARD™ 184 with 40%±1% Ni by volume, for the same sample temperatures and over the same range of wavelengths as shown in FIG. 11A.

Based on analysis of the test results shown in FIGS. 11A-11D, it was concluded that a microparticle percentage of about 30%±1% by volume provided a relatively greater average increase in thermal emissivity ε_{T} over the temperature range 23° C.-60° C. than the samples with the other spiky microparticle volume percentages.

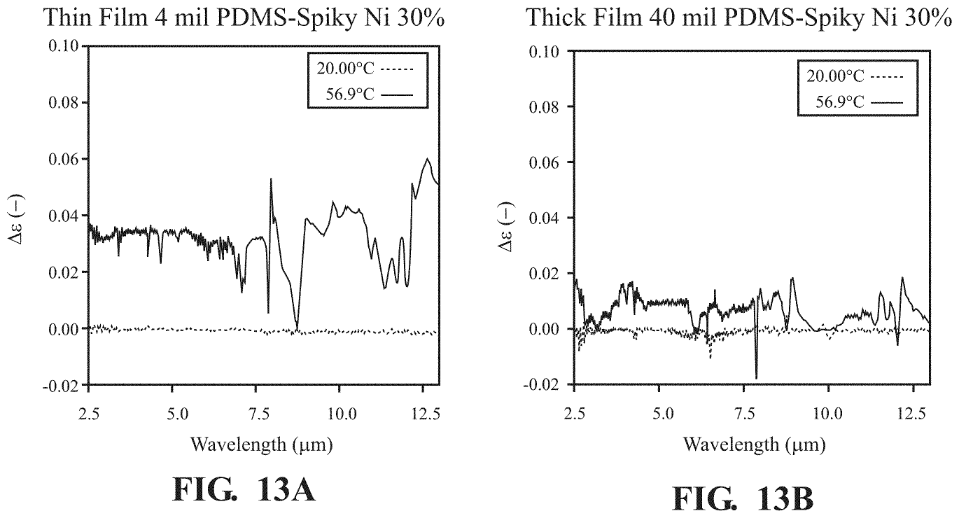

### Now do Brand (FIG. 12)

Following testing for purposes of determining the effect of varying the volume percentage of microparticles on thermal emissivity, additional test samples (structured similarly to samples 220) were prepared to evaluate the effect (if any) of varying the specific brand or type of PDMS used for the polymer matrix. The additional samples of the composite material were prepared using spiky-shaped nickel microparticles at a percentage by volume of 30% microparticles/70% polymer. Each of the samples had a thickness of 0.004±0.0004 inch. One sample used Sylgard™ 184 material and one sample used Ecoflex™ 00-20 material.

The variation of thermal emissivity with temperature for the different polymer matrix materials over the desired range of wavelengths is shown in FIGS. 12A-12B. FIG. 12A shows the change in emissivity with temperature for the sample using Sylgard™ 184 and FIG. 12B shows the change in emissivity with temperature for the sample using Ecoflex™ 00-20. Based on analysis of the test results shown in FIGS. 12A-12B, it was concluded that the Ecoflex™ 00-20 material provided a greater variation in change in thermal emissivity over the temperature range 23° C.-60° C. than the sample using Sylgard™ 184. On this basis, it was concluded that the Ecoflex™ 00-20 material is more effective at providing the desired variation in thermal emissivity with temperature.

Following testing for purposes of determining the effect of varying the specific brand or type of PDMS used for the polymer matrix, additional test samples (structured similarly to samples 220) were prepared to evaluate the effect (if any) of varying the thickness of the composite material covering a substrate or object. The additional test samples were formed from the Sylgard™ material previously described. The additional samples of the composite material were prepared using spiky-shaped nickel microparticles at a percentage by volume of 30% microparticles/70% polymer. One sample had a thickness in the range 0.040 (i.e., 40 mil)±0.0004 inches, and another sample had a thickness in the range 0.004 (i.e., 4 mil)±0.0004 inches,

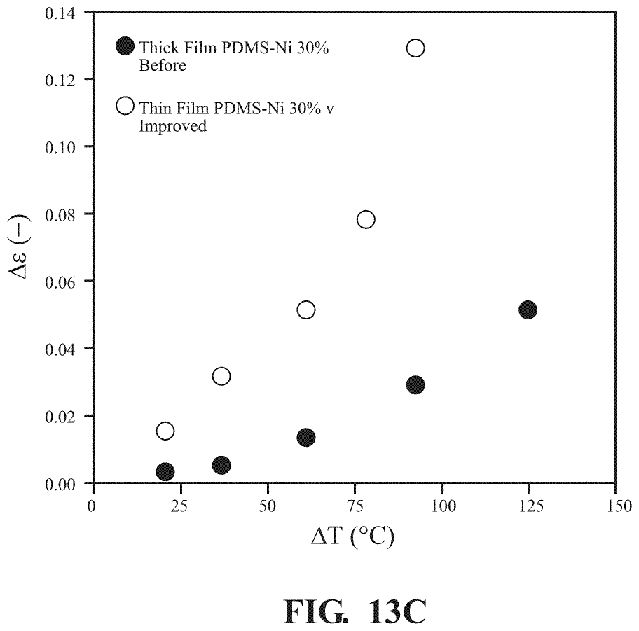

The variation of thermal emissivity with temperature for the different sample thicknesses tested is shown FIGS. 13A-13C. FIG. 13A shows the variation in change of emissivity with wavelength at various temperatures for the 0.004 thickness sample and FIG. 13B shows the variation in change of emissivity with wavelength at various temperatures for the 0.040 thickness sample. FIG. 13C shows the variation in change of emissivity with temperature for the 0.004 thickness sample and the 0.040 thickness sample. Based on analysis of the test results shown in FIGS. 13A-13C, it was concluded that the relatively thinner 4 mil sample exhibited a greater variation in thermal emissivity with temperature than did the 40 mil sample. On this basis, it was concluded that a relatively thinner layer of the composite material is more effective at providing the desired variation in thermal emissivity with temperature.

Following evaluation of the samples including different volume percentages of spiky microparticles, an attempt was made to evaluate the effect (if any) of microparticle shape on thermal emissivity ε_{T}. Referring to FIGS. 3A-3B, using the 30%±1 microparticle percentage by volume from the spiky-shaped microparticle sample tests as a guideline, an additional sample 220 of composite material was prepared using flaky-shaped microparticles 40c and the same PDMS matrix (i.e., the Sylgard™ material) used for the spiky-shaped microparticle sample 120. The samples had thicknesses of 0.004±0.0004 inch.

As well as composite material test samples 120, 220 using flaky and spiky microparticles as previously described, an additional test sample 320 was prepared incorporating spherical microparticles 40b having a 30%±1 microparticle percentage by volume, for comparison to samples 120 having flaky-shaped microparticles 40c and samples 220 having spiky-shaped microparticles 40a. Thus, for each shape of microparticle to be tested, suitable microparticle powders were used to prepare the additional sample 320 at a percentage by volume of 30% microparticles/70% polymer (including the thinner used for the PDMS polymer).

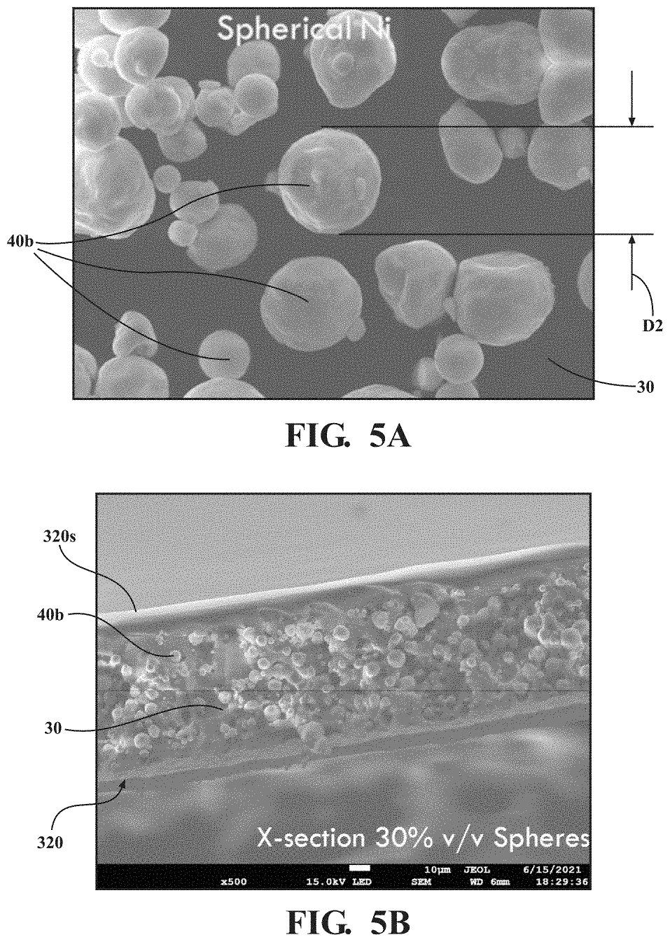

FIG. 5A shows a magnified view of examples of spherical microparticles (generally designated 40b) incorporated into the additional sample 320. FIG. 5B shows a magnified view of a cross-section of the composite material sample 320 incorporating spherical microparticles 40b into the polymer matrix 30 adjacent an outer surface 320s of the sample 320.

Referring to FIG. 5A, in particular arrangements, the spherical microparticles 40b may have diameters D2 in the range 3-11 μm inclusive. In one or more arrangements, the spherical microparticles 40b incorporated into the composite material may be provided by a spherical microparticle powder dispersed in the PDMS polymer material of matrix 30. A spherical microparticle powder suitable for preparation of a composite material as described herein is available in the form of Novamet Type 4SP−10 μm powder from Hart Materials Ltd.

The thermal emissivity of the sample 320 was measured using the diffuse-reflectance Fourier-transform-infrared (FTIR) instrument, as previously described. The thermal emissivity was measured over the temperature range 23° C.-60° C. to determine the infra-red energy being emitted by the sample at various wavelengths. The heating cell was again used to heat the test samples to the temperatures in the 23° C.-60° C. temperature range.

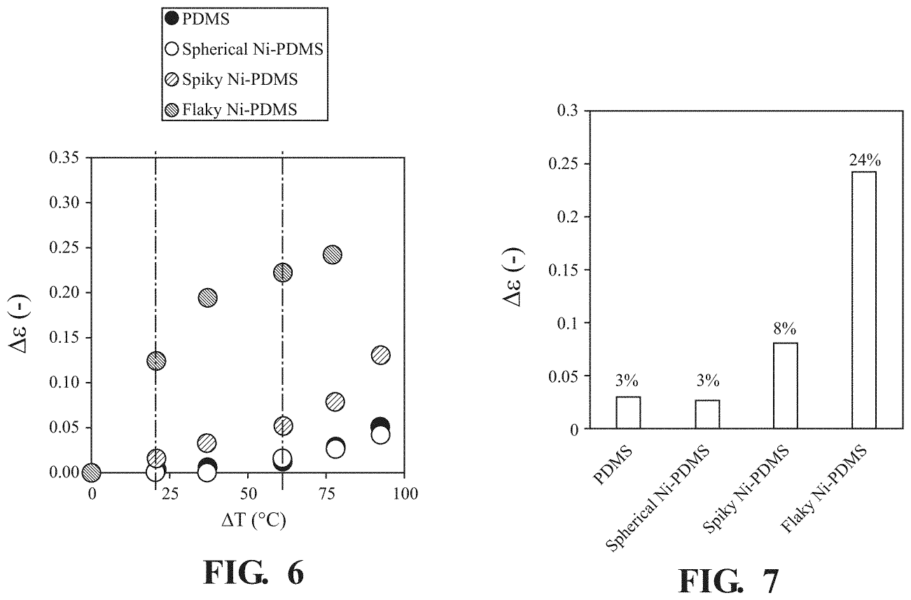

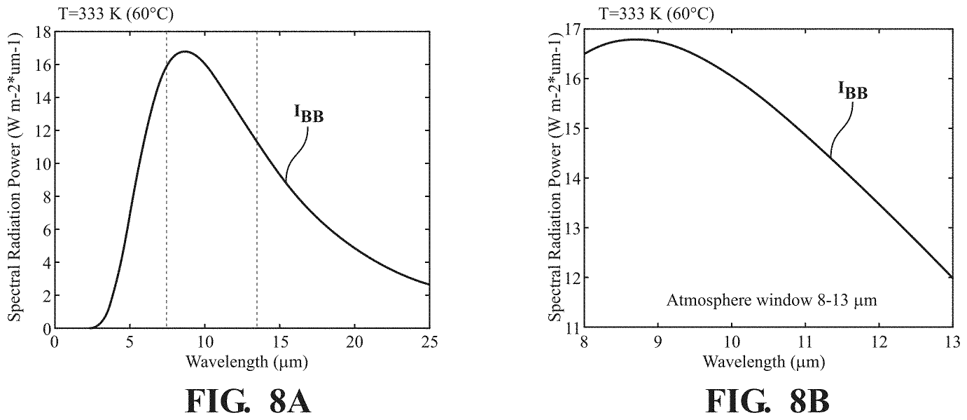

Results of thermal emissivity testing of composite material samples including the various types of microparticles at 30% by volume are shown in FIGS. 6 and 7, as well as for a sample comprised of PDMS material without microparticles. FIG. 6 is a graph showing the change in thermal emissivity with temperature in the sample for each microparticle shape, over the temperature range 23° C.-60° C. FIG. 7 is a bar graph summarizing changes in thermal emissivity over the temperature range 23° C.-60° C. for a sample including 30% by volume of each shape of microparticle tested. As seen from FIGS. 6 and 7, the flaky-shaped microparticle samples prepared with 30% microparticles/70% polymer exhibited a relatively larger increase (about 24%) in the amount by which thermal emissivity ε_{T} changes with increasing temperature T over the temperature range 23° C.-60° C. than did samples including other shapes of microparticles. It was also noted that the thermal emissivities of embodiments of the composite material fabricated with the spiky-shaped microparticles at 30% microparticles by volume exhibited an increase of about 8% in the amount by which thermal emissivity changes with increasing temperature over the temperature range 23° C.-60° C.

To determine the thermal power Pray radiated by a sample of the composite material over the 8-13 μm wavelength range, a solar absorber at temperature T, with spectral angular emissivity ε(λ, Ω) may be modeled. When the solar absorber is exposed to a clear daylight sky, it is subject to both solar irradiance, and thermal radiation from the atmosphere (corresponding to ambient air temperature T_{amb}). The steady-state temperature T of the solar absorber is determined by:

P_{rad}(T)−Pₐₜₘ(T_{amb})−Pₛᵤₙ+P_{cond+conv}=0 [1]

where P_{rad} (T)=thermal power radiated from the composite material over the 8-13 μm wavelength range as a function of temperature T of the PVA material, Pₐₜₘ (T_{amb})=thermal power received by the PVA from the atmosphere as a function of the temperature of atmosphere surrounding the PVA material, P_{cond+conv}=thermal power received by the PVA from a substrate or other structure to which the PVA is in thermal communication and to which is to be cooled by heat energy radiating from the PVA, and Pₛᵤₙ=thermal power received by the PVA from direct sunlight (as shown in FIG. 2).

In Eq. 1, the thermal power radiated by the solar absorber may be given by the relation:

P_{rad}(T)=∫dΩcos θ∫₀^{∞}dλI_{BB}ε(λ,Ω). [2]

Here, ∫dΩ=∫₀^{π/2}dθ sin ∫₀^{2π}dϕ is the angular integral over a hemisphere, I_{BB}(T, λ)=(2hc²/λ⁵)/┌e^{hc/(λkBT})−1┐ is the spectral radiance of a blackbody at temperature T, where h is the Planck constant, c is the velocity of light, k_{B} is the Boltzmann constant, and λ is wavelength.

From the test data, using a known method, a continuous curve for I_{BB} as a function of wavelength λ and temperature T may be generated, and a continuous curve of emissivity ε as a function of wavelength λ and temperature T may be generated. Then, per relationship (2), P_{rad} may be integrated over the 8-13 μm wavelength range to determine an estimated thermal emission power P_{rad} of the composite material over the 8-13 μm wavelength range at the given temperature T.

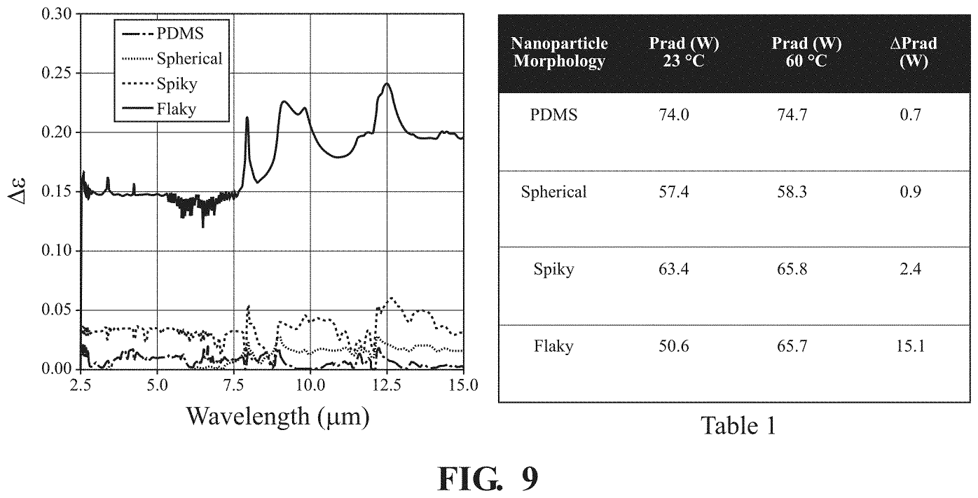

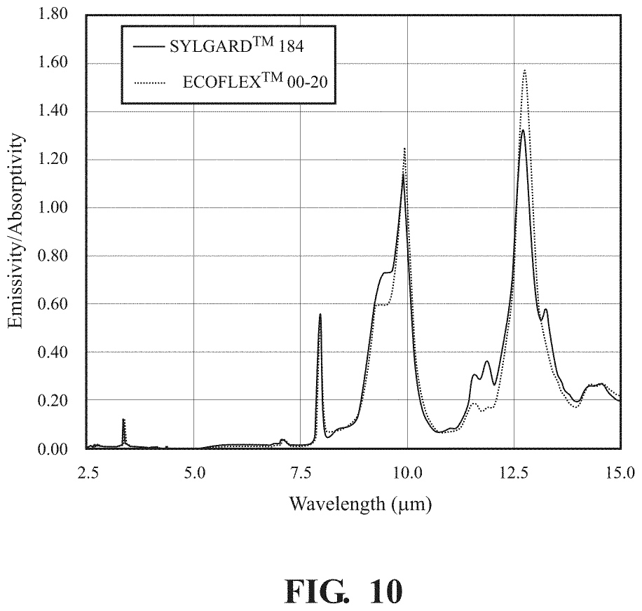

Determination of I_{BB} (T, λ) for a black body over the 8-13 μm wavelength range at a temperature of 60° C. is shown in FIGS. 8A-8B. For a black body (over the 8-13 μm wavelength range at a temperature of 60° C., P_{rad} is about 75.5 W/m². Continuous curves of changes in emissivity ε over the temperature range 23° C.-60° C. as a function of wavelength λ for samples of PDMS alone (i.e., with no microparticles added) and for samples including the various microparticle shapes (spherical, spiky, and flaky) at 30%±1% by volume as previously described are shown in FIG. 9. Table 1 shows the results of calculations of P_{rad} over the 8-13 μm wavelength range for each type of microparticle at temperatures of 23° C. and 60° C. using the test data and relationship (2).

It may be seen from Table 1 that PDMS alone exhibits the smallest change in emitted energy over the 8-13 μm wavelength range and over the 23° C.-60° C. temperature range. Also, because of its relatively high emissivity in the 8-13 μm wavelength range, the sample made from PDMS alone emits an amount of energy relatively close to that emitted by a black body at 60° C. It may also be seen that, in general, the composite material samples emit lower amounts of thermal energy in the 8-13 μm wavelength range at 60° C., due to the fact that the addition of metal to the PDMS lowers the thermal emissivity of the resulting composite material.

Based on analysis of the test results shown in FIGS. 13A-13C, it was concluded that the greatest change in energy emitted in the 8-13 μm wavelength range between 23° C. and 60° C. is exhibited by the sample 120 made with flaky microparticles at 30% by volume (15.1 W/m²), followed by the sample 220 made with spiky microparticles at 30% by volume (2.4 W/m²).

The foregoing description is provided for purposes of illustration and description and is in no way intended to limit the disclosure, its application, or uses. It is not intended to be exhaustive or to limit the disclosure. Individual elements or features of a particular embodiment or arrangement are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

The headings (such as “Background” and “Summary”) and sub-headings used herein are intended only for general organization of topics within the present disclosure, and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect or arrangement, or various aspects or arrangements means that a particular feature, structure, or characteristic described in connection with an embodiment or particular system is included in at least one embodiment or aspect. It should be also understood that the various method steps discussed herein do not have to be carried out in the same order as depicted, and not each method step is required in each aspect or embodiment.

1. A composite material comprising:
a polymer matrix; and
a quantity of electrically conductive microparticles dispersed within the polymer matrix in an amount and distribution structured so that the composite material exhibits an increase in thermal emissivity of at least about 8% with increasing temperature of the composite material, for temperatures over a range of 23° C.-60° C. inclusive.

2. The composite material of claim 1 wherein the microparticles comprise flaky-shaped microparticles.

3. The composite material of claim 2 wherein the flaky-shaped microparticles are dispersed within the polymer matrix in an amount of 30%±1% by volume.

4. The composite material of claim 1 wherein the microparticles comprise spiky-shaped microparticles.

5. The composite material of claim 4 wherein the spiky-shaped microparticles are dispersed within the polymer matrix in an amount of 30%±1% by volume.

6. The composite material of claim 1 wherein a polymer forming the matrix has a thermal emissivity of at least 0.90 for when the polymer is at a temperature within a range of 23° C.-60° C. inclusive.

7. The composite material of claim 1 wherein the polymer matrix comprises a polydimethylsiloxane (PDMS) resin.

8. The composite material of claim 1 wherein the microparticles comprise nickel microparticles.

9. The composite material of claim 1 wherein the quantity of electrically conductive microparticles is dispersed within the polymer matrix in an amount and distribution structured so that the composite material exhibits an increase in thermal emissivity of at least about 20% with increasing temperature of the composite material, for temperatures in the range of 23° C.-60° C. inclusive.

10. The composite material of claim 1 wherein a thickness of the material is 0.004±0.0004 inch.

11. A composite material comprising:
a polymer matrix having a thermal emissivity of at least 0.90 over a temperature range of 23° C.-60° C. inclusive; and
a quantity of electrically conductive flaky microparticles dispersed within the polymer matrix in an amount of 30%±1 by volume.

12. The composite material of claim 11 wherein a thickness of the material is 0.004±0.0004 inch.

13. (canceled)

14. (canceled)
